(19) United States
(12) Patent Application Publication
(10) Pub. No.: US 2004/0126302 A1
(43) Pub. Date: Jul. 1, 2004

(54) Method for continuous production of a hydrate composite

(76) Inventors: Olivia R. West, Knoxville, TN (US); Constantinos Tsouris, Oak Ridge, TN (US); Liyuan Liang, Oak Ridge, TN (US)

Correspondence Address: UT-Battelle, LLC, 111 Union Valley Rd., PO Box 2008, Mail Stop 6498, Oak Ridge, TN, 37831, US

(21) Appl. No.: 10/601,234

(22) Filed: Jun. 20, 2003

Related U.S. Application Data
(63) Continuation-in-part of application No. 09/981,126, filed on Oct. 16, 2001, now Pat. No. 6,598,407.

(51) Int. Cl. C01B 31/20

(52) U.S. Cl. 423/437.1

(57) ABSTRACT

Water is mixed with a hydrate-forming fluid (gas or liquid) within a pressurized, temperature-controlled continuous-flow reactor. Intense mixing of the hydrate-forming fluid with water forms many hydrate-encased water droplets of hydrate-forming fluid which are then allowed to consolidate into a solid-like hydrate/hydrate-forming fluid/water material.

### RELATED APPLICATIONS

This application is a Continuation-In-Part application of U.S. patent application Ser. No. 09/981,126, filed Oct. 16, 2001, and entitled “Method and Apparatus for Efficient Injection of CO₂ in Oceans”, the disclosure of which is incorporated by reference herein.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### TECHNICAL FIELD

The invention relates to a method for the production of a new hydrate composite material comprising consolidated hydrate, hydrate-forming fluid, and water phases. The consolidated material can be used in industrial applications where the controlled formation of hydrates is a key process component.

### BACKGROUND OF THE INVENTION

Clathrate hydrates, herein referred to as hydrates, are ice-like non-stoichiometric compounds that are stable under high pressures and low temperatures, and consist of guest molecules trapped in crystalline cages of hydrogen-bonded water molecules. Examples of hydrate-forming species include methane, ethane and other low molecular weight alkanes, carbon dioxide, and nitrogen. There is significant interest in hydrates because gas hydrate deposits are a naturally occurring energy resource, because the plugging of oil and gas production wells and pipelines can be due to hydrate formation, and because hydrates have utility in industrial applications when formed under controlled conditions.

Industrial processes where hydrate formation is being used or considered for application include desalination (Max et al., 2000); separation of CO₂ from power plant emissions (Kang et al., 2000); energy storage and transport (Gudmundsson et al., 2000); food production (Mitchell et al., 1967); Gupta et al., 2002); and ocean carbon sequestration (West et al., 2002). In most of these applications hydrates are made in closed, pressurized, temperature-controlled stirred tank reactors wherein water is mixed with hydrate-forming species to produce a hydrate slurry.

Our invention is a method for the controlled production of a new hydrate form comprising a hydrate, hydrate-forming species, and water consolidated into a cohesive, solid-like material. Other than our co-pending patent application Ser. No. 09/981,126 in the field of CO₂ ocean sequestration, no studies to date discuss or suggest the continuous generation of a composite material comprising a consolidated hydrate, hydrate-forming species, and water phases. The present invention has potential uses in industrial areas where continuous production of a hydrate-bearing solid or solid-like material in a continuous-flow reactor will result in improved process efficiency and reduced costs.

### REFERENCES

1. J. Gudmundsson, V. Andersson, 0. I. Levik, and M. Mork (2000); “Hydrate Technology for Capturing Stranded Gas” in Gas Hydrates: Challenges for the Future, G. D. Holder and P. R. Bishnoi (ed), Annals of the New York Academy of Sciences, Vol. 912, 403-410.

2. A. Gupta, B. Dimmel (2002); “Carbon Dioxide Hydrate Product and Method of Manufacture Thereof”; International Patent Application, International Publication No. WO 02/34065 A1, publication date May 2, 2002.

3. S. Kang, H. Lee (2000); “Recovery of CO₂ from Flue Gas Using Gas Hydrate: Thermodynamic Verification through Phase Equilibrium Measurements”; Environ. Sci. Technol., Vol. 34, 4397-4400.

4. M. D. Max, V. T. John, R. E. Pellenbarg (2000); “Methane Hydrate Fuel Storage in All-Electric Ships” in Gas Hydrates: Challenges for the Future, G. D. Holder and P. R. Bishnoi (ed), Annals of the New York Academy of Sciences, Vol. 912, 460-473.

5. W. A. Mitchell, K. Ronai, W. C. Seidel, U.S. Pat. No. 3,333,969, Issued Aug. 1, 1967.

6. T. J. Phelps, D. J. Peters, S. L. Marshall, O. R. West, L. Liang, J. G. Blencoe, V. Alexiades, G. K. Jacobs, M. T. Naney and J. L. Heck, Jr., “A New Experimental Facility for Investigating the formation and Properties of Gas Hydrates under Simulated Seafloor Conditions”, Rev. Sci. Instrum. Vol. 72, No. 2, pp. 1514-1521 (2001).

7. O. R. West, C. Tsouris, L. Liang, U.S. patent application Ser. No. 09/981,126, filed Oct. 16, 2001; published as U.S. Patent Application Publication No. US-2003-0070435-A1, Publication Date Apr. 17, 2003.

### OBJECTS OF THE INVENTION

It is a first object of the invention to provide a solid-like material comprising consolidated hydrate/hydrate-forming fluid/water phases, herein referred to as a hydrate composite.

Another object of the invention is to provide a method for continuous production of a hydrate composite material.

Another object of the invention is to provide a method for continuous production of a CO₂ hydrate composite material.

### SUMMARY OF THE INVENTION

In a first embodiment, the invention is a method for continuous production of a hydrate-containing material comprising the steps of delivering a fluid containing hydrate-forming species to a pressurized, temperature controlled, continuous-flow reactor; delivering water to the pressurized, temperature controlled, continuous-flow reactor; and mixing the fluid containing hydrate-forming species with the water within the pressurized, temperature controlled, continuous-flow reactor until a consolidated hydrate/fluid/water stream is formed.

### BRIEF DESCRIPTION OF THE DRAWINGS

FIG. 1 illustrates one embodiment of the invention wherein a hydrate-forming species in fluid form is mixed with water at a specific pressure and temperature to form a solid-like material comprising consolidated hydrate, hydrate-forming species, and water phases.

FIG. 2 is a series of photographs showing an example of the invention used to continuously produce CO₂ hydrate composite in a test facility. The figure shows the production of a solid-like CO₂-hydrate/CO₂-liquid/water material achieved by mixing water with liquid CO₂ before injection in water at a temperature of 5° C. and a pressure equivalent to 13 MPa. FIG. 2(a) shows a drop of liquid CO₂ released in water with no premixing with water; FIG. 2(b) shows the transition from drops to a consolidated stream by mixing liquid CO₂ with water; and FIGS. 2(c, d) show a steady flow of the consolidated stream.

FIG. 3 is a photograph showing the injector of FIG. 2 mounted horizontally in the test facility. The negatively buoyant consolidated stream of CO₂-hydrate/CO₂-liquid/water phases is produced at a pressure equivalent to a 1300-m ocean depth. The stream is observed to bend downward due to its negative buoyancy.

### DETAILED DESCRIPTION OF THE INVENTION

The hydrate composite production system of this invention is designed to produce a solid-like hydrate/hydrate-forming fluid/water consolidated material that can be used in applications where hydrate formation is a requisite process component. In this method, water is mixed with the hydrate-forming fluid (gas or liquid) within a pressurized, temperature-controlled continuous-flow reactor. Intense mixing of the hydrate-forming fluid with water forms many hydrate-encased water droplets of hydrate-forming fluid (primary particles) which are then allowed to consolidate into a solid-like hydrate/hydrate-forming fluid/water material.

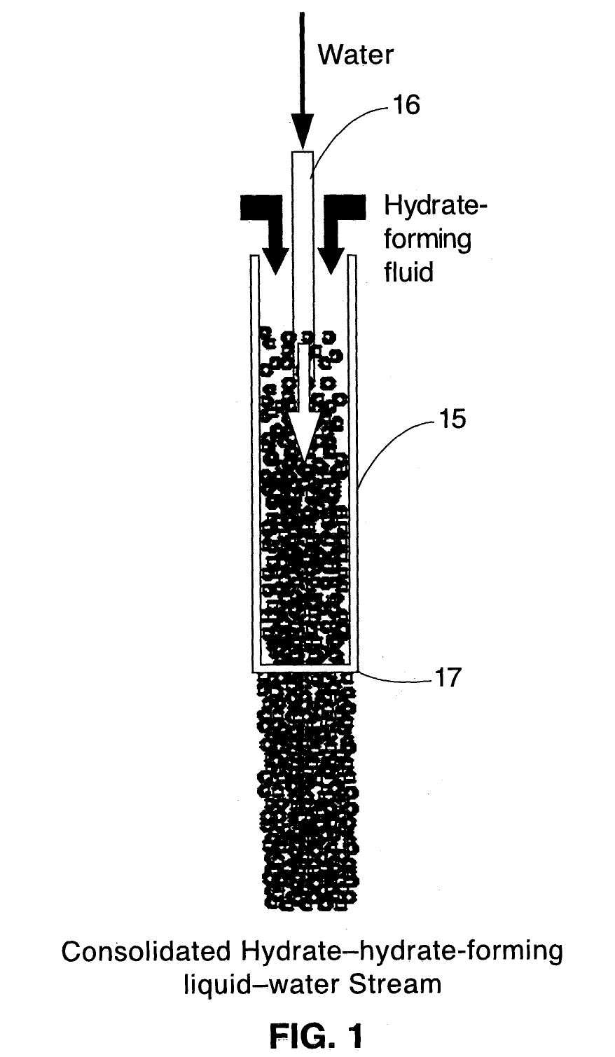

In FIG. 1, a discharge pipe, or injector, 15 is maintained at a predetermined pressure, and a hydrate-forming fluid is pumped into the pipe 15. Water is pumped into the pipe 15 through a second pipe 16. By this means, the water and hydrate-forming fluid are contacted in the pipe 15 at high Reynolds numbers to ensure turbulent conditions. Intense mixing at the point of contact leads to the formation of fine water droplets in the hydrate-forming fluid.

It is well established that hydrates are formed on the interfaces between water and a hydrate-forming fluid phase. Thus, the formation of droplets increases the interfacial area between the water and hydrate-forming fluid phase, which enhances the rate of hydrate formation. We have discovered that when the volume fraction of the droplet/dispersed phase is relatively high, the interfacial hydrate forming on the droplet surfaces interlinks into a solid framework that consolidates the water and hydrate-forming fluid phases into a solid-like composite material. By adjusting the flow-rate ratios between the water, the hydrate-forming fluid, and the residence time of the fluid in the pipe 15, the ratio of the three phases (hydrate, hydrate-forming fluid, and water) can be controlled at the discharge end 17 of the injector 15.

Various mixing devices can be designed to form the hydrate/hydrate-forming fluid/water consolidated material. The common features of these devices are: (1) contacting water with the hydrate-forming fluid in a wide range of water volume fractions to form an emulsion where small drops of one fluid are dispersed into the other fluid, and (2) allowing a sufficient time for hydrate to be formed on the interfacial areas between the hydrate-forming fluid and water in the emulsion, eventually forming a solid-like consolidated stream of hydrate, hydrate-forming fluid, and water phases. Examples of specific mixing devices include static or electrically-powered mixing blades emplaced in a hydrate-forming fluid discharge pipeline section where the hydrate-forming fluid and water come together. Entrainment and mixing of water with the hydrate-forming fluid in a discharge pipeline can also be achieved through a venturi or jet pump.

In further description of FIG. 1, the first pipe 16 receiving either of the fluids is located within the second pipe 15 receiving the second fluid. Mixing is controlled by manipulation of the flow rates of the fluids. An example is to have water supplied by pipe 16, and the fluid containing the hydrate-forming species flowing in the pipe 15. At the end of pipe 16, the water is injected into the fluid containing the hydrate-forming species. By increasing the water flow rate, three main flow regimes of water may be observed: (i) Rayleigh instability regime, (ii) transitional regime, and (iii) spraying regime. In our invention, it is usually desirable to work in the spraying regime, which is defined as a function of Reynolds and Ohnesorge dimensionless numbers, although the other regimes may also produce the consolidated stream.

Additional means of mixing may be also used. An example is a static mixer comprised of baffles fixed in pipe 15 of FIG. 1. As the mixture of fluids flows past the baffles of the static mixer, a shear flow is formed, which generates a dispersion of droplets of one fluid into the other. In this case, the consolidated stream is also formed by manipulation of the flow rates.

A laboratory test facility known as the Seafloor Process Simulator (SPS, Phelps 2001) located at the Oak Ridge National Laboratory was used to produce the consolidated hydrate composite material of this invention using a laboratory-scale version of the reactor shown in FIG. 1. The experiments illustrate the use of the hydrate composite material for ocean carbon sequestration, where conditions in the reactor are controlled to produce a negatively buoyant CO₂ hydrate composite. Negative buoyancy is a desired property in this application since the CO₂ hydrate composite discharged into the ocean is expected to increase the metastability of CO₂ storage in the ocean as well as reduce environmental impacts.

The SPS is made from Hastelloy C-22 (selected for resistance to seawater corrosion) with a reaction volume of 70 L (31.75-cm internal diameter, 91.4-cm internal height). A refrigerated, walk-in cooler provides temperature control for the vessel. The vessel is equipped with sapphire windows for visual observations and recording, as well as sampling ports for material collection and measuring devices such as thermocouples, pressure transducers, and pH probes. The vessel is also equipped with fluid delivery and recovery systems that allows fluid flow while maintaining constant pressurization. The SPS provides a well-controlled environment for conducting experimental simulations of pressurized fluid injections on a small scale.

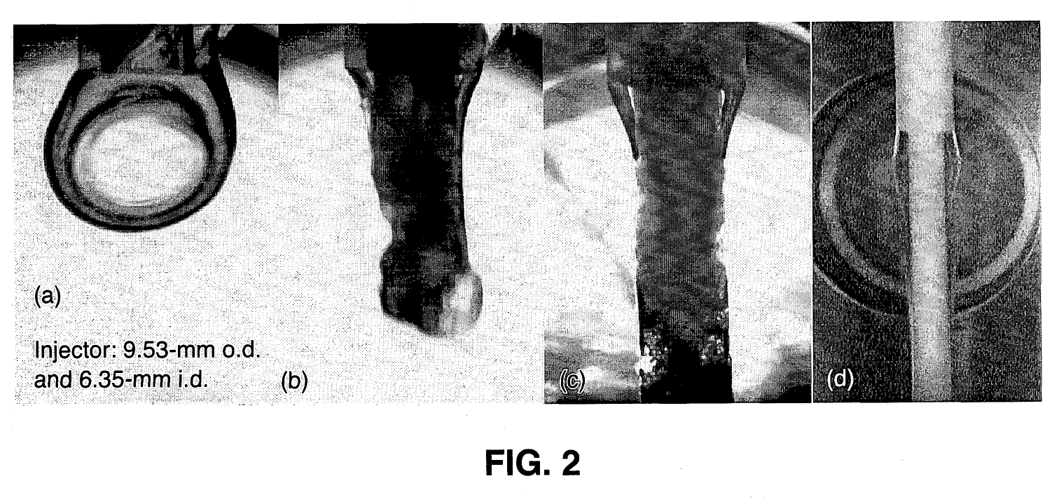

As expected for CO₂ ocean sequestration, injections in which seawater was not premixed with the CO₂ stream produced rising droplets of liquid CO₂, which eventually formed a thin translucent shell of CO₂ hydrate. By introducing water into liquid CO₂ through a capillary tube at varying flow-rate ratios, a paste-like stream of consolidated phases of CO₂ hydrate, liquid CO₂, and water under conditions typical of intermediate ocean depths (i.e., temperature=3-4° C., pressure=10.3-13.1 MPa) was achieved. This result is illustrated in FIG. 2, which shows the pipe-based injector 15 mounted vertically in the SPS in the direction of negative buoyancy. The photographs correspond to (a) a drop of liquid CO₂ released in water with no premixing with water; (b) transition from drops to a consolidated stream by mixing liquid CO₂ with water; (c, d) steady production of the negatively buoyant consolidated stream at 13.1 MPa, corresponding to 1300-m depth.

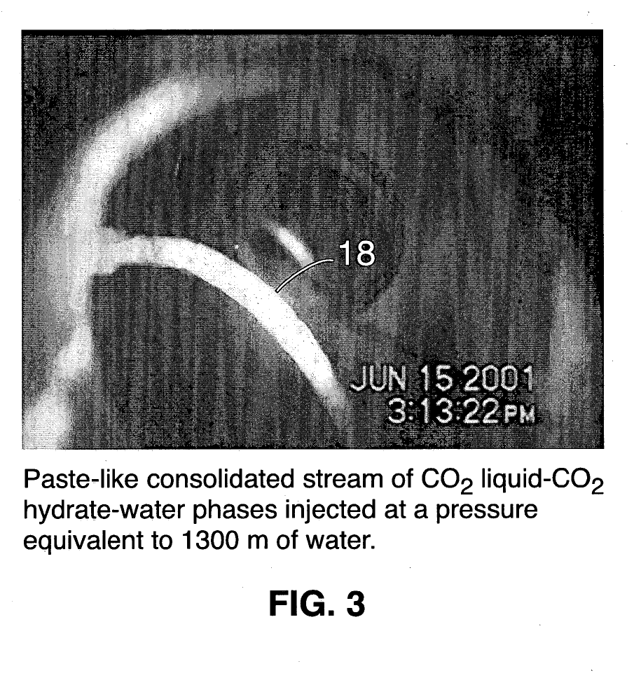

More evidence of the negative buoyancy of the consolidated hydrate is shown in FIG. 3. In FIG. 3, the pipe-based injector 15 was positioned horizontally in the vessel, and the injected stream is observed to bend downward because of its higher bulk density relative to that of seawater at that depth. We have also been able to generate a negatively buoyant CO₂ stream at pressures as low as 10.3 MPa, which corresponds to an ocean depth of ˜1000 m.

Based on several sets of experiments in the SPS using both fresh and artificial seawater (3.5% NaCl), we have found that the density of the hydrate stream produced by our injection system depends on the ratio of water and liquid CO₂ flow rates, the total flow rate through the injector, the pressure at the injection point, and the mixing energy. A sinking stream was consistently produced if the ratio of the water-to-liquid CO₂ flow rates is greater than 3. However, lower water-to-liquid CO₂ flow rates are possible under better mixing conditions.

The required flow-rate ratio appears to increase with decreasing pressure. For example, for 10.3 and 13.1 MPa, water-to-CO₂ ratios of 5 and 3 are required, respectively. A stream composed of a 25:8 volumetric mixture of liquid CO₂ and water progressed from positive to negative buoyancy as the pressure was increased from 10.3 MPa to 13.1 MPa. The effect of higher pressure likely results from a greater driving force for the conversion of CO₂ to CO₂ hydrate, as well as the presence of compressible liquid CO₂ in the consolidated stream.

A greater mixing intensity, which occurs at higher total flow rates through the injector, provided a larger interfacial area between water and liquid CO₂. This increased the mass transfer rate between CO₂ and water, and also increased the surface areas on which hydrates can nucleate and grow. Therefore, the combination of higher pressure and mixing intensity lead to a greater reaction rate for CO₂ hydrate formation and an increase in the bulk density of the hydrate stream produced by the injector. By controlling the degree of hydrate conversion in the reactor, the properties of the produced hydrate composite can also be controlled.

Another application for the hydrate composite material described in this invention is in food production, e.g., in the carbonation of water for beverages and in the preparation of frozen carbonated products. In the carbonation of beverages, it has been found that mixing carbon dioxide hydrate with water is more efficient than directly dissolving CO₂ into water. In order to control the dissolution of CO₂ hydrate when mixed with water, it is customary to compact hydrate particles at high pressure to form briquettes (Mitchell et al., 1967). Use of the composite hydrate product of our invention for water carbonation eliminates the need for the briquette process and can lead to a more streamlined and economical process.

For the production of a frozen carbonated product, the following steps are typically followed: (1) formation of CO₂ hydrate in an agitated, closed reactor where water, flavor syrup and CO₂ are mixed at low temperature and high pressure, (2) grinding of the CO₂ hydrate mixture into a powder, and (3) compaction and packaging of the CO₂ hydrate powder (Gupta et al., International Patent Application No. WO 02/34065). Using the hydrate production system shown in FIG. 1 and mixing the flavor syrup with the water before addition into the continuous-flow reactor can produce a hydrate composite that is ready for packaging. Thus, the grinding and compaction steps are no longer necessary.

While there has been shown and described what are considered the preferred embodiments of the invention, it will be obvious to those skilled in the art that various changes and modifications can be made without departing from the scope of the inventions defined by the appended claims.

We claim:

1. A method for continuous production of a hydrate-containing material comprising the steps of:
delivering a fluid containing hydrate-forming species to a pressurized, temperature controlled, continuous-flow reactor;
delivering water to said pressurized, temperature controlled, continuous-flow reactor; and
mixing said fluid containing hydrate-forming species with said water within said pressurized, temperature controlled, continuous-flow reactor until a consolidated hydrate/fluid/water stream is formed.

2. The method of claim 1 wherein said pressurized, temperature controlled, continuous-flow reactor is a pipe, said water is injected into said pipe, and said consolidated hydrate/fluid/water stream flows from said pipe following said mixing step.

3. The method of claim 2 wherein said pipe includes static mixer blades.

4. The method of claim 1 wherein said continuous-flow reactor also includes:
means for controlling the flow rate of said fluid containing hydrate-forming species into said continuous-flow reactor;
means for introducing and controlling the flow rate of said water to said fluid containing hydrate-forming species in said continuous-flow reactor;
temperature control means for controlling the temperature of said continuous-flow reactor; and
a pressure control device for controlling the pressure within said continuous-flow reactor.

5. The method of claim 4 wherein said means for controlling the flow rate of said fluid containing hydrate-forming species is a mass flow controller.

6. The method of claim 4 wherein said means for introducing and controlling the flow rate of said water to said fluid containing hydrate-forming species in said continuous-flow reactor is a pump equipped with a flow controller.

7. The method of claim 4 wherein said means for introducing and controlling the flow rate of said water to said fluid containing hydrate-forming species in said continuous-flow reactor is a jet pump.

8. The method of claim 4 wherein said continuous-flow reactor further includes static mixing blades for mixing said fluid containing hydrate-forming species and said water.

9. The method of claim 4 wherein said continuous-flow reactor further includes electrically powered mixing blades for mixing said fluid containing hydrate-forming species and said water.

10. The method of claim 1 wherein said consolidated hydrate/fluid/water stream is a consolidated CO₂-hydrate/CO₂-liquid/water stream.
